(19) United States
(12) Patent Application Publication
(10) Pub. No.: US 2014/0169037 A1
(43) Pub. Date: Jun. 19, 2014

(54) MODULE COMPRISING LIGHT-EMITTING DIODES AND LUMINOUS GLAZING WITH SUCH A DIODE-COMPRISING MODULE

(71) Applicants: Mathieu Berard, Paris (FR); Jean-Philippe Mulet, Montreuil (FR); Fabienne Piroux, Compiegne (FR); Laurent Massol, Montauban (FR)

(72) Inventors: Mathieu Berard, Paris (FR); Jean-Philippe Mulet, Montreuil (FR); Fabienne Piroux, Compiegne (FR); Laurent Massol, Montauban (FR)

(73) Assignee: SAINT-GOBAIN GLASS FRANCE, Courbevoie (FR)

(21) Appl. No.: 14/113,159

(22) PCT Filed: Apr. 26, 2012
(86) PCT No.: PCT/FR2012/050925

§ 371 Date: Nov. 6, 2013

(30) Foreign Application Priority Data
Apr. 28, 2011 (FR) 1153641

(51) Int. Cl. H05B 33/08

(52) U.S. Cl. CPC H05B 33/0821
USPC 362/612; 315/192; 362/545; 362/311.02

(57) ABSTRACT

A module includes light-emitting diodes, with a printed circuit board bearing light-emitting diodes connected by a series-parallel electrical circuit including a number of circuit branches powered by a common electrical power supply, each branch including two peripheral diodes and optionally at least one internal diode. At least one of the multidiode branches includes at least one reference internal diode, the two diodes closest the reference diode belonging to a branch or branches other than said multidiode branch and/or at least one of the two-diode branches includes two reference peripheral diodes and has, as the closest diode on the printed circuit board, a diode belonging to a branch other than the two-diode branch.

The invention relates to a module comprising light-emitting diodes, in particular comprising a printed circuit board bearing a number of light- emitting diodes, and to a luminous glazing unit incorporating such a light-emitting-diode-comprising module.

Light-emitting diodes are small optoelectronic components that, under the effect of a current, emit light rays in a spectral range extending from the near UV to the near IR.

Light-emitting diodes (LEDs) are increasingly incorporated into glazing units.

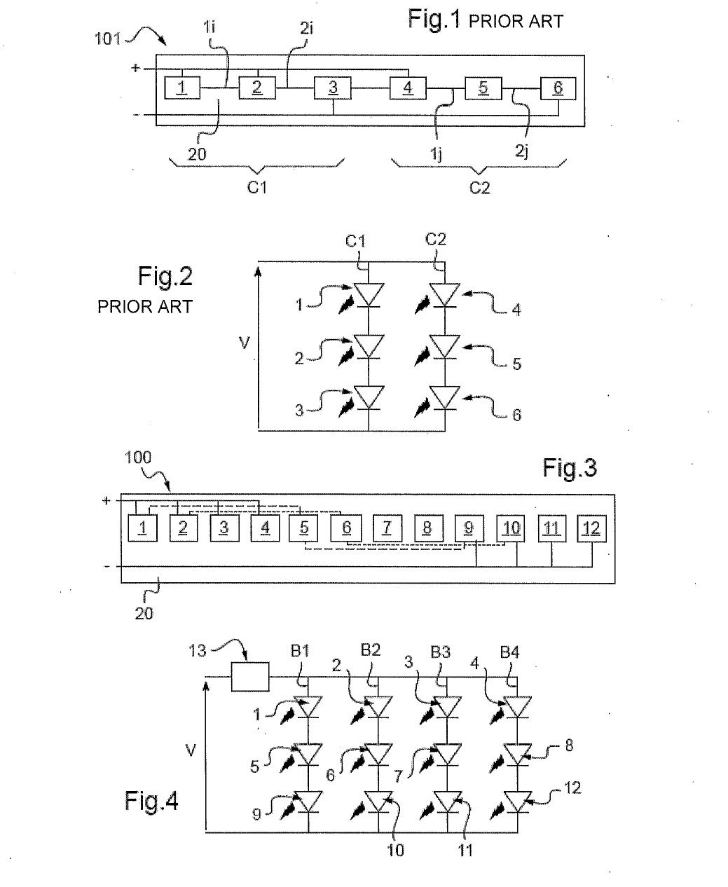

It is known to place light-emitting diodes in a line on a printed circuit board (PCB). The module 101 thus formed, often called a “strip” comprises, for example, on the board 20 a line of six diodes numbered 1 to 6 from one end of the board to the other, as shown in FIG. 1. These diodes are “biased” components, i.e. they have a positive and negative terminal, and current can only flow through them in one direction (from the positive “+” terminal to the negative “−” terminal). Thus, to connect two diodes in series, it is essential not to connect together two terminals of the same polarity. The diodes 1 to 6 are powered by a DC voltage source. The first diode 1 (on the left-hand side of the module) is connected in series via a first electrical track 1i to the second diode 2, itself then connected in series, via a second electrical track 2i, to the third diode 3. Diodes 1 to 3 thus connected form a first branch. C1 of the electrical circuit. A second branch C2 is formed by connecting the fourth diode 4 in series, via a third electrical track 1j, to the fifth diode 5, itself then connected in series, via a fourth electrical track 2j, to the sixth diode 6. The two branches C1, C2 are connected in parallel in the electrical circuit shown in FIG. 2. The electrical circuit thus formed therefore comprises two branches C1, C2 connected in parallel, each of the branches comprising three diodes connected in series: a “series-parallel” circuit then being spoken of.

In order to produce a luminous glazing unit that is illuminated via its edge face, this module is placed facing the edge face of the glazing pane with the light-emitting side of the diodes lying parallel to the glazing pane. The light propagates in the glazing pane, which forms a light guide, and is extracted via one of the main faces by light-scattering means such as a sand-blasted, etched or acid-attacked region of the glazing pane.

Light-emitting diodes, which are components based on semiconductor crystals, are relatively fragile. If they are not treated with care, their lifetime is much shorter that their forecasted theoretical lifetime.

An unacceptable degradation in the luminous performance of the diode-comprising luminous glazing unit results therefrom.

There is therefore a need to make the diode module more reliable and to guarantee the longevity of the illumination function of the luminous glazing unit comprising this diode-comprising module.

For this purpose, the invention provides a module comprising light-emitting diodes, the module also comprising a printed circuit board bearing light-emitting diodes electrically connected by a series-parallel electrical circuit thus comprising a number of circuit branches powered by a common electrical power supply and connected in parallel, each branch comprising two peripheral light-emitting diodes and optionally at least one internal light-emitting diode, the peripheral diodes and the internal diode thus being connected in series.

At least one of the branches, called a multidiode branch, comprises at least one reference internal diode, the two diodes closest the reference diode on the printed circuit board belonging to a branch or branches other than said multidiode branch, and/or at least one of the branches, called a two-diode branch, comprises a number M of diodes equal to 2, each of the diodes being a peripheral diode called a reference diode and having as the closest diode on the printed circuit board a diode belonging to a branch other than said two-diode branch.

The advantage of this combination is that it makes the thus designed diode-comprising module more reliable and more durable.

The main factor degrading a diode and thus impacting its lifetime is excessive temperature, resulting from a thermal problem, for example poor thermal dissipation of heat produced locally by the diode, and/or an electrical problem, for example too high a current flowing through the diode. This has the effect of increasing the amount of heat generated by this diode. This will then impact not only the temperature of this diode but also that of its neighbors. Thus, in the diode-comprising module of the prior art (shown in FIG. 1) an “avalanche” effect'is observed when a diode fails, i.e. the defect propagates from a diode'to nearby diodes.

Let it be assumed that a thermal problem arises in the second diode 2 and that this diode ceases to function. In this case, the first diode 1 and the third diode 3, which are the nearest diodes, possibly subjected to the same thermal stress, are also subjected to an electrical “stress”. Specifically, if the defect in the second diode 2 is such that its resistance drops to zero (short-circuit), then the current flowing through diodes 1 and 3 will increase and their heat dissipation, and therefore their temperature, will also increase. Immediately, there is a risk that these two diodes 1, 3 will also cease to function, thereby leaving half, i.e. a large region, of the module 101 inoperative.

The invention reduces this avalanche effect by decoupling (at least partially) the electrical schema and the physical position of the diodes on the printed circuit board in order to limit and even stop the propagation of diode defects due to thermal and electrical effects.

Thus, the risk that the defect of a thus isolated, defective diode (diode that no longer turns on) will propagate is limited and thus the module dims only in one or more areas, each of which is clearly defined. Therefore, with the invention, the number of closely spaced defective diodes is limited and therefore the size of the dim (nonluminous) region is reduced.

Preferably, such defect propagation is at least prevented for the one or more diodes that are the most important from the point of view of the optical performance required, for example the'one or more most central diodes, especially in the case of a glazing unit that is illuminated via its edge face.

The peripheral diodes are connected to the rest of the circuit, for example directly connected to the other branches.

Preferably, to simplify the circuit:
most (even all) of the branches are multidiode branches each at least mainly (even only) comprising reference internal diodes or most (even all) of the branches are two-diode branches each mainly (even only) comprising reference peripheral diodes and preferably the diode closest, on the printed circuit board, to each peripheral diode in a multidiode branch belongs to a branch other than the multidiode branch; and/or
at least most (even all) of the branches comprise the same number of diodes and the diodes preferably have the same operating voltage and are even identical.

Thus, in particular, the two following configurations are preferred:
all the branches are multidiode branches and all the internal diodes are reference internal diodes—all the branches preferably comprising the same number of diodes, especially the same number of identical diodes—and, preferably, the diode closest, on the printed circuit board, to each peripheral diode in a multidiode branch belongs to a branch other than the multidiode branch, or else the two diodes closest, on the printed circuit board, to each peripheral diode in a multidiode branch belong to a branch or branches other than said multidiode branch (thus, especially the two peripheral diodes of each multidiode branch are not nearest neighbors) and furthermore, the total number of diodes in all of the multidiode branches is not a prime; and
all the branches are two-diode branches and all the diodes are reference internal diodes, the diodes especially being identical.

In one advantageous embodiment, for a given (or each) branch, the distance between two diodes that are connected to each other, called the intragroup distance, is adjusted depending on the power dissipated by the diodes, on the heat resistance of the diodes and on the thermal conductivity of the printed circuit board.

In another advantageous embodiment, the intragroup distance between two reference internal diodes in a given multidiode branch or of two reference peripheral diodes in a two-diode branch is larger than 10 mm or even larger than 20 mm and is preferably smaller than 200 mm or even smaller than 100 mm.

Preferably, the power supply is a DC power supply, especially a voltage supply, and preferably a 12 V power supply, especially for incorporation of the module into a vehicle, or in which the power supply is the mains, especially 220 V or 110 V mains supply, especially for architectural applications, and the module optionally comprises a regulating resistor common to the branches and connected to the electrical power supply or comprises a transformer connected to the electrical power supply and/or the module comprises in each branch an internal regulating resistor.

The diodes are preferably regularly distributed over a region or all of the board. For example, the diodes are equidistant. However, depending on the required optical performance, it may be desired to tailor the density of the diodes.

Thus, the diodes may be separated from each other, on the printed circuit board, by a given constant interdiode distance or, when the interdiode distance is not constant, the maximum interdiode distance may be less than 20 times, even less than 10 times, or else less than 5 times, the minimum interdiode distance, and optionally, when the distance between two diodes on the circuit board is sufficiently large, the two diodes belong to the same branch.

The diodes may be placed on the printed circuit board in (at least) one line and each reference internal diode is directly connected to two diodes in its multidiode branch, which two diodes are further away from the reference internal diode than its two nearest neighbors in the line.

The diodes may be placed on the printed circuit board in an integer number N of lines, especially in at least one line comprising four diodes (and preferably most of the lines comprising four diodes), the circuit being divided into N electrically connected series-parallel subcircuits and each of the subcircuits being associated with a separate line.

The diodes may be placed on the printed circuit board in a number of lines, the branches of the series-parallel electrical circuit being formed by linewise connection of the diodes.

The diodes may be placed on the printed circuit board in a number of lines, the branches of the series-parallel electrical circuit being formed by connecting diodes belonging to a number of lines, and in which, in the case of a matrix arrangement, especially in a square or rectangular pattern, at least one reference internal diode or one reference peripheral diode is preferably directly connected to a diode on a diagonal and especially to a diode in a nonadjacent line (thus at least one line is skipped).

In another advantageous embodiment, most of the branches, even all of the branches, comprise no electronic components other than said diodes.

An identical current may flow through each diode of a given branch.

However, adding components such as resistors to the branches may be envisioned, for example following the peripheral diodes of the branches.

The diodes may typically be a few mm, less than 1 cm, in size (width).

A linear regulator may be placed between the electrical power supply and the (peripheral) diodes of each branch directly connected to the electrical power supply.

A linear current regulator is a component that delivers a calibrated and constant current to the diodes if it is powered by a voltage source that provides it both with a minimum voltage and a minimum power. The regulator allows both possible power-supply (voltage-supply) overvoltages to be “absorbed” and the operation of the diodes in the module to be tightly controlled (preset nominal current). The regulator allows electrical defects related to the voltage source to be prevented complementing the connection arrangement according to the invention and averting problems that could arise in the module itself.

In another advantageous embodiment, the branches comprise the same number of diodes and the diodes have the same operating voltage, and for each branch each diode is assigned a row depending on its position in the branch, each connection point of a diode in a given row being connected to a connection point of a diode in the same row in another branch.

These bridges between branches allow the module to be made even more reliable because if a diode in a branch ceases to function (open circuit) the diodes belonging to its branch continue to function.

The diodes preferably emit white light. The operating voltage across their terminals is then typically between 2 and 5 V.

To provide illumination by extraction of guided light, the module generally faces the edge face of the glazing pane but may also be located in a hole produced on the border of a main face of the glazing pane.

The diodes may be side-emitting diodes, the printed circuit board and the emitting faces of the chips are then parallel to the glazing pane, for example placed facing the edge face of the glazing pane.

Each light-emitting diode may comprise at least one semiconductor chip, and preferably each diode in a given branch is identical.

In the case of a 220 V (110V, respectively) power supply, it may be preferred to limit the number of branches, each branch comprising many diodes, for example at least 40 (20, respectively), especially diodes emitting white light.

In the case of a 12 V power supply, branches comprising three diodes, especially three white-light-emitting diodes, may be preferred.

The diodes may for example have a beam half-angle of 60°.

The invention is applicable to any diode module used in a context where reliability is of the utmost importance. These modules may be integrated into or used in association with any type of system, in particular glazing units comprising mineral or organic glass panes: automotive glazing units (glass roofs, side windows, windshields, rear-view mirrors, rear side windows, other windows, etc.); glazing units for other means of transport (trains, airplanes, boats, etc.); architectural glazing units (curtain walling, windows for homes, etc.), decorative glazing units (mirrors, glass wall panels, balustrades, doors, shelves, furniture elements, etc.); glazing units for commercial refrigerators (glass shelves or doors); and glazing units for household appliances (glass-ceramic hobs, glass oven doors, etc.).

Thus, a luminous glazing unit is provided, especially for a vehicle, comprising a light-emitting-diode-comprising module as defined above and optically coupled to the glazing pane.

The light-emitting-diode-comprising module may be arranged so that light rays propagate in the thickness of the glazing pane, which thus forms a light guide, and is especially optically coupled to the edge face of the glazing pane, and in which the glazing pane comprises means for extracting the guided light, for example on one of its main faces or produced by internal laser etching.

The glazing unit may be a monolithic or multiple glazing unit (laminated, insulating, evacuated, etc. glazing unit). The glazing unit may be flat or curved.

The module may be encapsulated in a polymer encapsulation on the periphery of the glazing pane, especially if it is intended for automotive applications.

The module may be mounted on the glazing pane using a strip, especially a metal strip, comprising a central part and at least one lateral part (on one of the main faces of the glazing pane).

In the optical coupling region (i.e. the light-injection region), the glazing pane, which is preferably made of mineral glass, may be coated with a masking (and therefore sufficiently opaque or black) element, which is preferably an enamel and/or an encapsulation and/or the glazing pane, made of organic glass, especially of polycarbonate, may be tinted (and therefore sufficiently opaque or black) through a fraction of its thickness, masking the optical coupling region (the part of the organic glazing that is still transparent).

The invention is particularly beneficial for glazing units in which the diode module cannot be easily replaced, for example a glazing unit (especially for a vehicle) illuminating by extraction of guided light in which the diode module is surrounded by a polymer encapsulation (on the periphery of the glazing pane). The lifetime of such a luminous glazing unit comprising a module according to the invention is potentially increased relative to a luminous glazing unit comprising a prior-art module because point defects do not affect the uniformity of the luminous area and therefore the luminous glazing still meets its specifications (it does not need to be replaced).

Furthermore, by the invention, the distance at which the beams mix is closer to the edge of the glazing pane to be illuminated by extraction of guided light, thereby allowing the position, extent and shape of the light-scattering means to be more freely chosen.

By the invention, by limiting the number of closely spaced defective diodes, the dim (nonluminous) zone is decreased in size. In particular, in the case of a glazing unit where the diode module illuminates by extraction of guided light, the dim region is confined to an edge region that is sufficiently narrow that the luminous performance of the glazing unit is not adversely affected. Preferably, this may be an edge region with no light-scattering means. For example, this edge region (a few mm to a few tens of mm in size) is masked by a frame, for example the lateral part or leg of a U-shaped strip that bears the module, in particular for an architectural and/or decorative glazing unit. In the case of an automotive glazing unit, this edge region may also be masked by a (conventionally employed) opaque black enamel and/or by a (conventionally employed) peripheral polymer encapsulating the glazing pane, such as described, for example, in patent application WO 2010/049638, or else by an opaque (black) part of a polycarbonate glazing pane.

The polymer encapsulation, which is especially 0.5 mm to a number of cm in thickness, is preferably obtained by overmolding.

In automotive applications, the encapsulating material is generally black or tinted (for esthetical and/or masking purposes). The encapsulation may be made of polyurethane (PU), especially of RIM (reaction injection molding) PU. Other materials that may be overmolded are:
flexible thermoplastics:
   thermoplastic elastomers (TPEs), especially thermoplastic elastomers based on polypropylene (PP)/styrene-ethylene-butadiene-styrene (SEBS), thermoplastic polyurethane (TPU) or polypropylene (PP)/EPDM; and
   polyvinyl chloride (PVC) or ethylene-propylene-diene (EPDM) terpolymer, or
rigid thermoplastics:
   polycarbonate (PC), polymethyl methacrylate (PMMA), polyethylene (PE), polypropylene (PP), polyamide (PA66), acrylonitrile butadiene styrene (ABS), and their blends (ABS/PC), polystyrene (PS), acrylonitrile styrene acrylate (ASA).

The overmolded material may be tinted and/or filled with glass fibers.

A one-, two- or three-component primer layer, for example based on polyurethane, polyester, polyvinyl acetate, isocyanate, etc., for example from 5 to 50 μm in thickness, is placed between the encapsulation and the glazing pane, in particular if it is a mineral glass glazing pane, because this layer promotes adhesion to mineral glass.

Overmolding also provides an attractive finish and allows other elements or functions to be incorporated:
overmolded frames;
reinforcing inserts or inserts for fastening the glazing unit, especially for windows that can be opened;
a multi- (two-, three-, etc.) lipped sealing strip that is compressed after fitting to the body; and/or
a trim.

The overmolding may take any shape, and may be lipped or lipless.

Tubing, also referred to as closed-cell sealing strip, may also be adhesively bonded to the overmolding.

Preferably, for a roof, the encapsulation is flush with one of the main faces of the glazing pane.

More generally, the luminous glazing unit with the module according to the invention may comprise an element for masking any possible parasitic light (especially on the face opposite the light extraction region, near the injection region), and/or for masking the attachment of the glazing unit to the body of the vehicle, the masking element possibly being:
a (sufficiently opaque, black) polymer encapsulation as described above; and/or
a sufficiently opaque enamel, placed on the periphery of one of the main faces of the glazing pane or on a face of a sheet of film added to one of the main faces, especially when the overmolding is single- or double-sided; and/or
a reflective surface (layer, etc.) on the periphery of one of the main faces of the glazing pane; and/or
when the glazing is made of an organic material, especially polycarbonate, a transparent and opaque two-material component.

Other features and advantages of the invention will now be described with regard to the drawings in which:

FIG. 3 shows a schematic view of a first diode-comprising module 100 in a first embodiment of the invention;

FIG. 4 shows a diagram of the electrical circuit corresponding to the first embodiment of the invention;

FIG. 5 shows a schematic top view of a luminous glazing unit with a diode-comprising module 1001 according to the prior art;

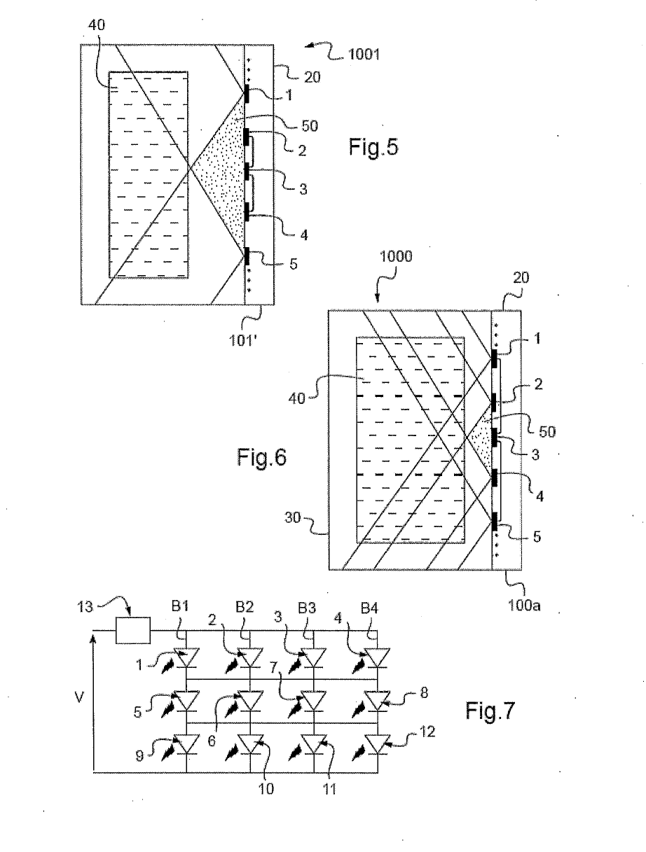

FIG. 6 shows a schematic top view of a luminous glazing unit with a diode-comprising module 1001 according to the invention;

FIG. 7 shows a diagram of the electrical circuit corresponding to a variant of the first embodiment of the invention;

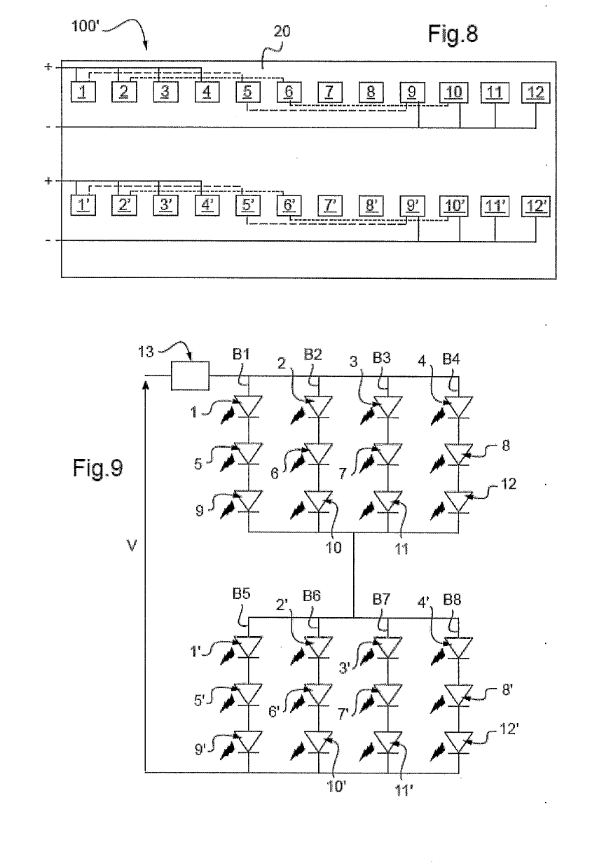

FIG. 8 shows a schematic view of a diode-comprising module 100′ in a variant of the first embodiment of the invention;

FIG. 9 shows a diagram of the electrical circuit corresponding to the embodiment of the invention in FIG. 8;

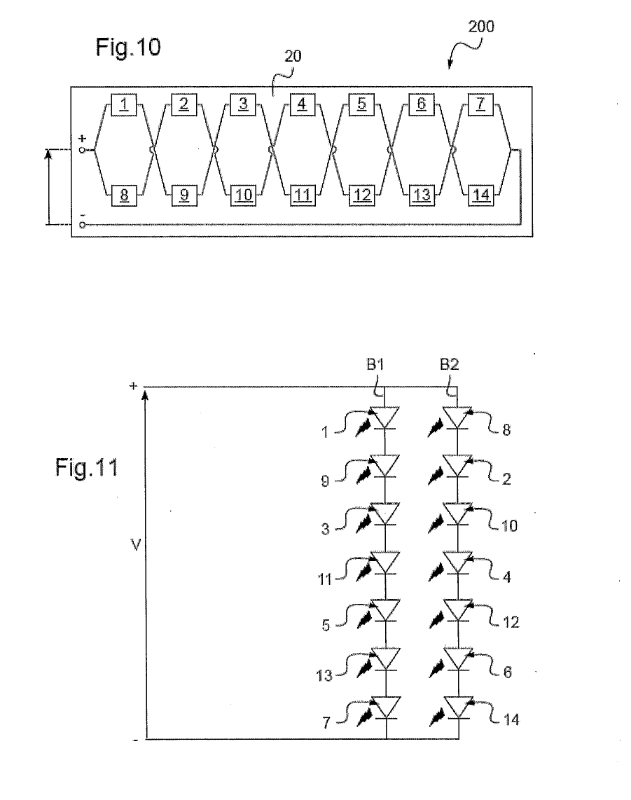

FIG. 10 shows a schematic view of a second diode-comprising module 200 in a second embodiment of the invention;

FIG. 11 shows a diagram of the electrical circuit corresponding to the second embodiment of the invention;

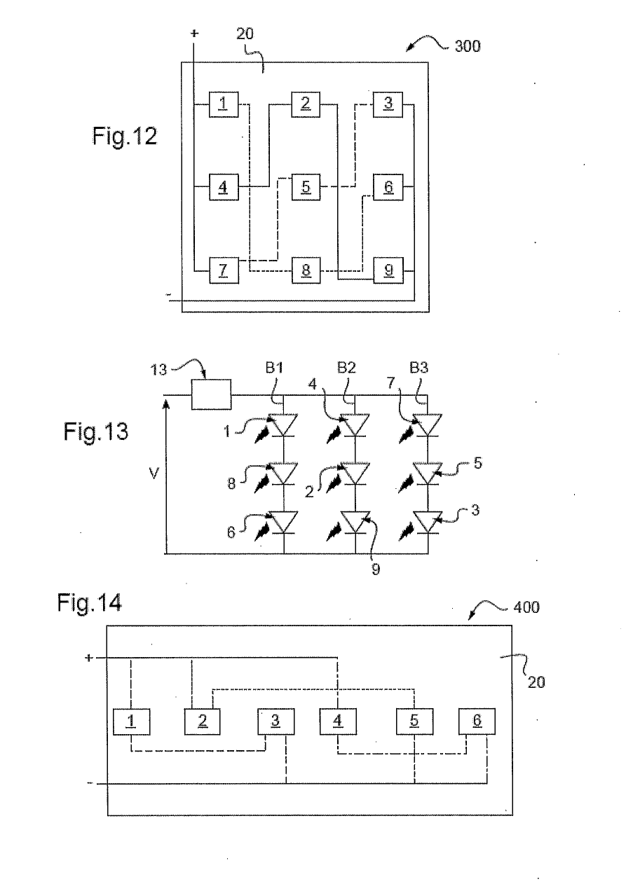

FIG. 12 shows a schematic view of a third diode-comprising module 300 in a third embodiment of the invention;

FIG. 13 shows a diagram of the electrical circuit corresponding to the third embodiment of the invention;

FIG. 14 shows a schematic view of a fourth diode-comprising module 400 in a fourth embodiment of the invention;

FIG. 15 shows a diagram of the electrical circuit corresponding to the fourth embodiment of the invention; and

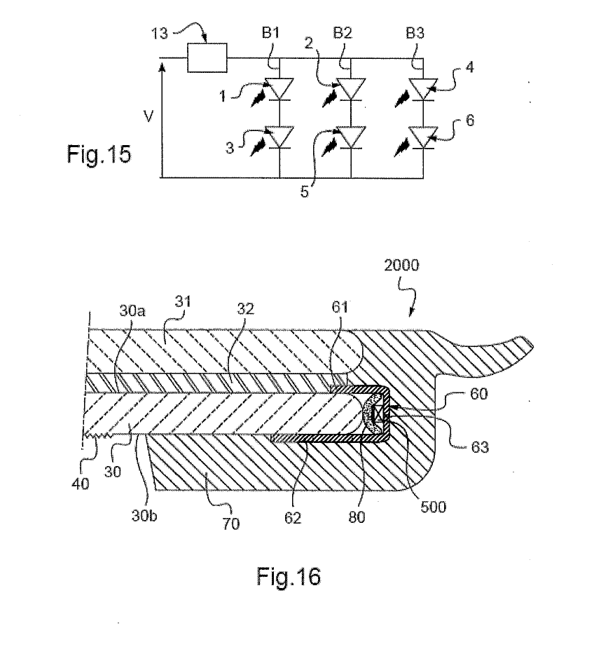

FIG. 16 shows a schematic view of a luminous glazing unit 2000 with a diode-comprising module 500 similar to the module of the first embodiment of the invention.

The drawings are not to scale.

FIG. 3 shows a schematic top view of a first diode-comprising module 100 in a first embodiment of the invention.

The following components are placed on a rectangular PCB 20 200 mm in length and 7 mm in width:
twelve diodes numbered 1 to 12 in a line from one end of the strip to the other, said diodes being spaced 12 mm apart from one another;
a linear regulator 13 (cf. FIG. 4) sold under the reference LM317 by National Semiconductor; and
a calibrating resistor (not shown), associated with the regulator, allowing a current of 80 mA to be delivered to each of the branches, the DC supply voltage being fixed at 12 V.

The diodes for example emit white light with an average flux of 6 lumens. Diodes from the manufacturer

Nichia sold under the reference NSSW088A are for example chosen.

The module thus designed has an average luminous efficiency of 57 lm/W (average flux=45 lm; average power consumed=0.79 W).

A series-parallel circuit (the circuit diagram of which is shown in FIG. 4), comprising four branches B1 to B4 each containing three diodes that are not neighbors on the board 20, is formed:
the first branch B1 thus consists of three diodes in series, the diodes being numbered 1, 5 and 9 (diodes 1 and 9 being peripheral diodes and diode 5 being a reference internal diode);
the second branch B2 thus consists of three diodes in series, the diodes being numbered 2, 6 and 10 (diodes 2 and 10 being peripheral diodes and diode 6 being a reference internal diode);
the third branch B3 thus consists of three diodes in series, the diodes being numbered 3, 7 and 11 (diodes 3 and 11 being peripheral diodes and diode 7 being a reference internal diode); and
the fourth branch B4 thus consists of three diodes in series, the diodes being numbered 4, 8 and 12 (diodes 4 and 12 being peripheral diodes and diode 8 being a reference internal diode).

An interlaced connection system is thus produced. To make it easier to understand, all the connection tracks have not been shown in FIG. 3, only the tracks connecting the two first branches B1 and B2 being shown (using two types of dotted lines).

The first diode 1 (on the left-hand side of the figure) is thus connected in series via a first electrical track to the fifth diode 5, itself then connected in series via a second electrical track to the ninth diode 9.

The second diode 2 is connected in series via a third electrical track to the sixth diode 6, itself then connected in series via a fourth electrical track to the tenth diode 10.

All the internal diodes 5 to 8 are reference internal diodes, i.e. they are isolated to prevent the avalanche effect described above. Furthermore, each peripheral diodes has, on the printed circuit board, as its nearest neighbor (or nearest neighbors), a diode (or two diodes) in a branch other than its multidiode branch. Furthermore, two peripheral diodes of a given multidiode branch are not nearest neighbors on the printed circuit board. To form a luminous glazing unit for a vehicle, it is known to insert a rectangular strip comprising side-emitting diodes on the edge face of a glazing pane.

It is preferable, in order to simplify the circuit, for the total number of diodes in all of the multidiode branches not to be a prime.

FIG. 5 thus shows a top view of such a luminous glazing unit 1001 with a glazing pane 30 and light-scattering means 40 and, facing the edge face, a conventional module 101′ comprising a PCB 20 with a plurality of diodes 1 to 5 in a series-parallel circuit. Five diodes are illustrated and neighboring diodes 2, 3 and 4 are shown connected in series.

A defect in diode 3 (internal diode of its branch) causes diodes 1 and 4 (peripheral diodes of the branch) to fail and the resulting dim region 50 (dotted area) is of substantial size. To prevent the malfunction from being seen and the glazing unit from being scrapped, the luminous zone 40 (dashed area) must be placed at a sufficient distance away from the diodes.

FIG. 6 shows a top view of a luminous diode-comprising glazing unit 1000 comprising a glazing pane 30 with light-scattering means 40 and, facing the edge face, the module 100a according to the invention, the module 100a comprising a PCB 20 with a plurality of diodes 1 to 5 in a series-parallel circuit. Five diodes are illustrated and the three neighboring diodes 2, 3 and 4 do not belong to the same branch.

Failure of the internal diode 3 of the branch does not cause the peripheral diodes of the branch to fail and the resulting dim region 50 (dotted area) is limited.

FIG. 7 shows a diagram of the electrical circuit corresponding to a variant of the first embodiment of the invention.

In each branch each diode is assigned a row depending on its position in the branch, each connection point of a diode in a given row being connected to a connection point of a diode in the same row in another branch.

FIG. 8 shows a schematic top view of a diode-comprising module 100′ in a variant of the first embodiment of the invention.

The diodes are placed on the printed circuit board in two lines of twelve diodes 1 to 12 (first line) then 1′ to 12′ (second line) each with the same connection scheme as the first embodiment.

FIG. 9 shows a circuit diagram corresponding to the embodiment of the invention in FIG. 8.

The circuit is divided into two series-parallel subcircuits of four branches B1 to B8 comprising three electrically connected diodes, each of the subcircuits being associated with a separate line.

The fifth branch B5 comprises diodes 1′, 5′ and 9′. The sixth branch B6 comprises diodes 2′, 6′ and 10′. The seventh branch B7 comprises diodes 3′, 7′ and 11′. The eighth branch B8 comprises diodes 4′, 8′ and

As a variant, the branches of the series-parallel circuit are formed by linewise connection of the diodes: only one series-parallel circuit of eight branches, each of three diodes, then being formed.

FIG. 10 shows a schematic view of a second diode-comprising module 200 in a second embodiment, of the invention.

Fourteen diodes 1 to 14 are placed on the printed circuit board 20 in two lines, each of seven diodes, the branches of the series-parallel electrical circuit being formed by connecting the diodes belonging to the two lines according to a matrix arrangement, in a square (or rectangular) pattern.

FIG. 11 shows a diagram of the electrical circuit corresponding to this second embodiment of the invention.

Two branches B1, B2 each of seven diodes 1, 9, 3, 11, 5, 13 and 7 on the one hand and 8, 2, 10, 4, 12, 6 and 14 on the other hand, are formed.

Each reference internal diode 9, 3, 11, 5, 13 on the one hand and 2, 10, 4, 12, 6 on the other hand is connected to two diodes on the (first) diagonal.

FIG. 12 shows a schematic top view of a third diode-comprising module 300 in a third embodiment of the invention.

Nine diodes 1 to 9 are placed on the printed circuit board in three lines, each of three diodes, the branches of the series-parallel electrical circuit being formed by connecting diodes belonging to the three lines according to a matrix arrangement, in a square (or rectangular) pattern.

FIG. 13 shows a diagram of the electrical circuit corresponding to the third embodiment of the invention.

Three branches B1, B2, B3 of three diodes 1, 8 and 6 then 4, 2 and 9 and finally 7, 5 and 3, are formed.

Each reference internal diode 8, 2 and 5 is connected to two diodes in the two other lines.

FIG. 14 shows a schematic view of a fourth diode-comprising module 400 in a fourth embodiment of the invention.

The module 400 differs from the first module 100 in that the number of diodes has been decreased to 6 and in that the three branches B1′ to B3′ have been chosen to be two-diode branches.

Each reference peripheral diode 8, 2 and 5 is connected to a diode that is not its own neighbor. The first branch B1′ comprises diodes 1 and 3. The second branch B2′ comprises diodes 2 and 5. The third branch B3′ comprises diodes 4 and 6.

FIG. 15 shows a diagram of the electrical circuit corresponding to the fourth embodiment of the invention.

FIG. 16 shows a partial schematic cross-sectional view of a luminous glazing unit 2000 with a diode-comprising module 500 that is similar to the module 100 of the first embodiment of the invention.

This luminous glazing unit 2000 comprises a laminated glazing pane comprising:
a first transparent sheet 30, for example a rectangular sheet, having a first main face 30a and a second main face 30b, and a preferably rounded edge face (to prevent flaking), for example a sheet of soda-lime-silica glass 2.1 mm in thickness; and
a second glass sheet 31, optionally providing a solar-control function, the glass sheet being tinted (Venus VG10 glass for example) and/or covered with a solar-control coating and 2.1 mm in thickness.

The second glass sheet is laminated to the first glass sheet via a lamination interlayer 32 that is for example a PVB sheet 0.76 mm in thickness.

A U-shaped strip 60 supporting the light-emitting-diode-comprising module 500 lies bordering the glazing pane and is attached to the first glass sheet 30.

This strip 60 is monolithic, made of metal (stainless steel, aluminum), thin (being 0.2 mm in thickness) and has a central part 63 and two legs 61 and 62 that are positioned against the faces 30a and 30b.

The light-emitting diodes each comprise an emitting chip able to emit one or more wavelengths in the visible, the emitted beams being guided in the first sheet 30. The diodes are small, typically a few mm or less in size, especially being about 2 mm×2 mm×1 mm in size, have no associated optics (lens) and are preferably not pre-encapsulated so as to minimize their bulk.

The distance between the part bearing the diodes and the edge face is minimized, for example to 5 mm. The distance between the chip and the edge face is from 1 to 2 mm.

The main emission direction is here perpendicular to the face of the semiconductor chip, the chip for example comprising a multi-quantum-well active layer produced in AlInGaP technology or another semiconductor technology.

The light cone is a Lambertian cone of ±60°.

The extraction region 40 may preferably be produced, on the face 30b placed inside the vehicle, by any means: sand-blasting, acid attack, scattering layer, laser etching, etc.

A means for sealing from fluids 80 is placed between the module 500 and the edge face of the first sheet 30.

The luminous glazing unit 2000 is provided with a polymer encapsulation 70 about 2.5 mm in thickness bordering the glazing unit. This encapsulation, here covering the module 500 and diode support 60, provides a long-term seal (from water, cleaning products, etc.).

The encapsulation 70 also provides an attractive finish and allows other elements or functions (reinforcing inserts, etc.) to be integrated.

The encapsulation 70 has a lip and is double-sided. The encapsulation 70 is for example made of black polyurethane, especially RIM (reaction injection molding) PU. This material is typically injection molded at a temperature of up to 130° C. and at a pressure of a few tens of bars.

The black encapsulation material 70 is not transparent to the visible light emitted by the diodes.

In order for the encapsulation to be fitted flush an upper part of the edge face of the second glass sheet 31 is preferably left free.

The module 100 may for example form a fixed panoramic roof for a ground-based vehicle, or as a variant for a boat, etc. The roof is fitted from the exterior to the body via an adhesive.

As a variant, the encapsulation is modified in the following way:
the lip is omitted;
inserts for attaching the module are added, for opening it; and
tubing made of EPDM is added against the encapsulation, i.e. a closed-cell sealing strip or a multi-lipped sealing strip is added, the strip being compressed after fitting to the vehicle.

The multi-lipped sealing strip may also be an integral part of the encapsulation.

The first sheet 30 is on the interior side of the vehicle. Extraction preferably occurs via the face 30b.

Diodes emitting white or colored light may be chosen for background lighting, light for reading, etc.

The module 500 may, as a variant, be located on a lateral or longitudinal edge of the sheet 30.

Of course, a number of modules may be provided, on a given edge or on separate edges, having identical or separate functions (the choice depending on the power of the diodes, on the light emitted and on the position and the extent of the extraction regions).

The extraction region may form a luminous graphic, for example a logo or a trademark, a changing light (for children, etc.).

1. A module comprising:
light-emitting diodes; and
a printed circuit board bearing the light-emitting diodes electrically connected by a series-parallel electrical circuit comprising a plurality of circuit branches powered by a common electrical power supply and connected in parallel, each branch comprising two peripheral diodes and optionally at least one internal diode, the peripheral diodes and the internal diode being connected in series,
wherein at least one of the branches is a multidiode branch that comprises at least one reference internal diode, the two diodes closest the reference diode on the printed circuit board belonging to a branch or branches other than said multidiode branch, and/or
at least one of the branches is a two-diode branch, each of the diodes of the two-diode branch being a reference peripheral diode and having as the closest diode on the printed circuit board a diode belonging to a branch other than said two-diode branch.

2. The module as claimed in claim 1, wherein most of the branches are multidiode branches each at least mainly comprising reference internal diodes and the diode closest, on the printed circuit board, to each peripheral diode in a multidiode branch belongs to a branch other than the multidiode branch or wherein most of the branches are two-diode branches each mainly comprising reference peripheral diodes.

3. The module as claimed in claim 1, wherein at least most of the branches comprise the same number of diodes.

4. The module as claimed in claim 1, wherein all the branches are multidiode branches and all the internal diodes are reference internal diodes and the diode closest, on the printed circuit board, to each peripheral diode in a multidiode branch belongs to a branch other than the multidiode branch, or the two diodes closest, on the printed circuit board, to each peripheral diode in a multidiode branch belong to a branch or branches other than said multidiode branch, or wherein all the branches are two-diode branches each comprising reference peripheral diodes.

5. The module as claimed in claim 1, wherein for a given branch, the distance between two diodes that are connected to each other is adjusted depending on the power dissipated by the diodes, on the heat resistance of the diodes and on the thermal conductivity of the printed circuit board.

6. The module as claimed in claim 1, wherein the distance between two reference internal diodes in a given multidiode branch or of two reference peripheral diodes in a two-diode branch is larger than 10 mm.

7. The module as claimed in claim 1, wherein the power supply is a DC power supply, and wherein the module optionally comprises a regulating resistor common to the branches and connected to the electrical power supply or comprises a transformer connected to the electrical power supply and/or the module comprises in each branch an internal regulating resistor.

8. The module as claimed in claim 1, wherein the diodes are separated from each other, on the printed circuit board, by a given constant interdiode distance or, when the interdiode distance is not constant, the maximum interdiode distance is less than 20 times times the minimum interdiode distance, and wherein optionally, when the distance between two diodes on the circuit board is sufficiently large, the two diodes belong to the same branch.

9. The module as claimed in claim 1, wherein the diodes are placed on the printed circuit board in at least one line and each reference internal diode is directly connected to two diodes in its multidiode branch, which two diodes are further away from the reference internal diode than its two nearest neighbors in the line.

10. The module as claimed in claim 1, wherein the diodes are placed on the printed circuit board in an integer number N of lines, the circuit being divided into N electrically connected series-parallel subcircuits and each of the subcircuits being associated with a separate line.

11. The module as claimed in claim 1, wherein the diodes are placed on the printed circuit board in a plurality of lines, the branches of the series-parallel electrical circuit being formed by linewise connection of the diodes.

12. The module as claimed in claim 1, wherein the diodes are placed on the printed circuit board in a plurality of lines, the branches of the series-parallel electrical circuit being formed by connecting diodes belonging to a plurality of lines, and wherein, at least one reference internal diode or one reference peripheral diode directly connected to a diode on a diagonal.

13. The module as claimed in claim 1, wherein most of the branches comprise no electronic components other than said diodes.

14. The module as claimed in claim 1, wherein an identical current flows through each diode of a given branch.

15. The module as claimed in claim 1, wherein a linear regulator is placed between the electrical power supply and the diodes of each branch directly connected to the electrical power supply.

16. The module as claimed in claim 1, wherein the branches comprise the same number of diodes and the diodes have the same operating voltage, and for each branch each diode is assigned a row depending on its position in the branch, each connection point of a diode in a given row being connected to a connection point of a diode in the same row in another branch.

17. A luminous glazing unit comprising the module as claimed in claim 1 and optically coupled to a glazing pane.

18. The luminous glazing unit as claimed in claim 17, wherein the module is arranged so that light rays propagate in the thickness of the glazing pane which thus forms a light guide, and is optically coupled to an edge face of the glazing pane, and wherein the glazing pane comprises means for extracting the guided light.

19. The luminous glazing unit as claimed in claim 17, wherein the module is encapsulated in a polymer encapsulation on the periphery of the glazing pane.

20. The luminous glazing unit as claimed in claim 17, wherein the module is mounted on the glazing pane using a strip, comprising a central part and at least one lateral part on one of the main faces of the glazing pane.

21. The luminous glazing unit as claimed in claim 17, wherein, in the optical coupling region, the glazing pane is coated with a masking element and/or wherein the glazing pane is tinted through a fraction of its thickness, masking the optical coupling region.

22. The module as claimed in claim 3, wherein the diodes have the same operating voltage.

23. The module as claimed in claim 6, wherein the distance is larger than 20 mm and is smaller than 100 mm.

24. The module as claimed in claim 12, wherein the at least one reference internal diode or one reference peripheral diode is directly connected to a diode in a nonadjacent line.

25. The luminous glazing unit as claimed in claim 17, wherein said unit is configured to be arranged in a vehicle.
